(19) United States
(12) Patent Application Publication
(10) Pub. No.: US 2008/0183520 A1
(43) Pub. Date: Jul. 31, 2008

(54) METHODS AND APPARATUS FOR EVALUATING AN ORGANIZATION

(75) Inventors: Andrew W. Cutts, New London, NH (US); Dennis McGrath, Hartland, VT (US); Ernest W. Drew, Providence, RI (US)

Correspondence Address: BELL, BOYD & LLOYD, LLP, P.O. Box 1135, CHICAGO, IL, 60690, US

(73) Assignee: Norwich University, Northfield, VT (US)

(21) Appl. No.: 11/941,803

(22) Filed: Nov. 16, 2007

Related U.S. Application Data
(60) Provisional application No. 60/859,647, filed on Nov. 17, 2006.

(51) Int. Cl. G06Q 10/00; G06G 7/48

(52) U.S. Cl. 705/7

(57) ABSTRACT

Methods and apparatus are disclosed for developing scenarios for cyber exercises useful for evaluating the ability of an organization's infrastructure to handle situational anomalies. The methods and apparatus facilitate identification of a plurality of cyber elements, a plurality of participants, and a plurality of objectives for the exercise scenario. A gamespace is then created for the exercise scenario including an information technology topology and a transaction topology. Preferably, a hierarchical process is used to develop the cyber elements of the exercise scenario including defining a high level problem chain, a detailed problem chain, and a master scenario events list. The method and apparatus are capable of supporting a complex and dynamically changing environment having at least one player in a scenario-based exercise. Additionally, the method and apparatus allows for the design, implementation and modification of an exercise scenario that can be validated during each phase of development and/or implementation.

### CROSS REFERENCE TO RELATED APPLICATIONS

This present application is related to and claims benefit of U.S. Provisional Patent Application Ser. No. 60/859,647, filed Nov. 17, 2006, which is incorporated by reference herein in its entirety.

### FIELD OF THE INVENTION

This disclosure relates generally to evaluating the infrastructure of an organization and more particularly to the design and implementation of a scenario for a cyber exercise for use in evaluating the ability of an infrastructure to handle situational anomalies.

### BACKGROUND

Terrorist attacks, natural disasters and system failures are just some situations that may occur which can impair or eliminate the ability of an organization to function on an effective and continuous basis. In order to ensure the ability of the organization to function properly, administrators are tasked with trying to reduce the vulnerability of the organization to such anomalous events, such as by trying to prevent and/or minimize the risk of disruption and any potential damage that may be caused by such events. In order to accomplish this, certain precautions are typically taken to ensure operation, safeguard information and to guarantee that all critical elements of the organization are able to function properly without disruption. These precautions may include establishment of procedures to handle anomalous events, from both an administrative and operational viewpoint, the offsite storage of critical data in multiple locations, the implementation of backup server systems and the establishment of redundant communication systems to ensure that all necessary elements of the organization are able to communicate as required.

Another precaution that may be taken involves evaluating the vulnerabilities of an organization to identify possibly problematic areas. Currently, there are tools available to help administrators recognize areas that may be vulnerable to undesirable outside influences. However, these tools are typically limited to specific applications (e.g., computer networks), specific subject areas (e.g., financial institutions) or to single organizations having localized entities and are thus insufficient for evaluating situations that involve multiple organizations or organizations that have multiple separate entities. For example, with regard to information technology systems, network simulation tools are available that can help an administrator visualize what devices are in the applicable network and how those devices are interconnected. In addition, these tools may allow the administrator to make certain assumptions about devices outside of the organization that have a direct relationship with one or more devices inside of the organization. Unfortunately however, these network simulation tools are limited in that they are only applicable to Information Technology (IT) networks and are not capable of being combined with other evaluation tools.

This limited capability and lack of robustness is undesirable because as organizations become larger and more diverse (e.g., comprising national and/or international facilities/divisions) or as they become more interactive with other organizations (e.g. such as via joint ventures), the task of developing situational awareness and evaluating vulnerabilities has become much more difficult. One reason for this is that typically several organizations or entities should be evaluated simultaneously or in conjunction with each other, wherein each of the entities being evaluated might have different objectives. Another reason is that, in some situations, it can take a long period of time to design and implement an evaluation exercise, during which period the groups involved can radically change due to operational commitments and player concerns for risk.

### SUMMARY

A method and apparatus for developing scenarios useful for evaluating an organization is provided, wherein the method and/or apparatus is capable of supporting a complex and dynamically changing environment having at least one player in a scenario-based exercise. Additionally, the method and apparatus provided allows for the design, implementation and modification of an exercise scenario that can be validated during each phase of development and/or implementation.

Additional features and advantages are described herein, and will be apparent from, the following Detailed Description and the figures.

### BRIEF DESCRIPTION OF THE FIGURES

The foregoing and other features and advantages of the disclosed system will be more fully understood from the following detailed description of illustrative embodiments, taken in conjunction with the accompanying figures in which like elements are numbered alike.

FIG. 1 is a block diagram illustrating the components of an example exercise design.

FIG. 2 is a block diagram outlining one example of a method for evaluating an organization.

FIG. 3 is a block diagram outlining one embodiment of the relationship between enterprises and sectors in a gamespace.

FIG. 4 is a block diagram outlining one example of a scenario development team.

FIG. 5 is a block diagram outlining one example of a network or IT topology.

FIG. 6 is an example of a vignette schedule showing cycles of activity.

FIG. 7 is an example of a detailed problem chain table.

FIG. 8 is a block diagram illustrating one example method for developing and implementing an exercise scenario used to evaluate an organization.

### DETAILED DESCRIPTION

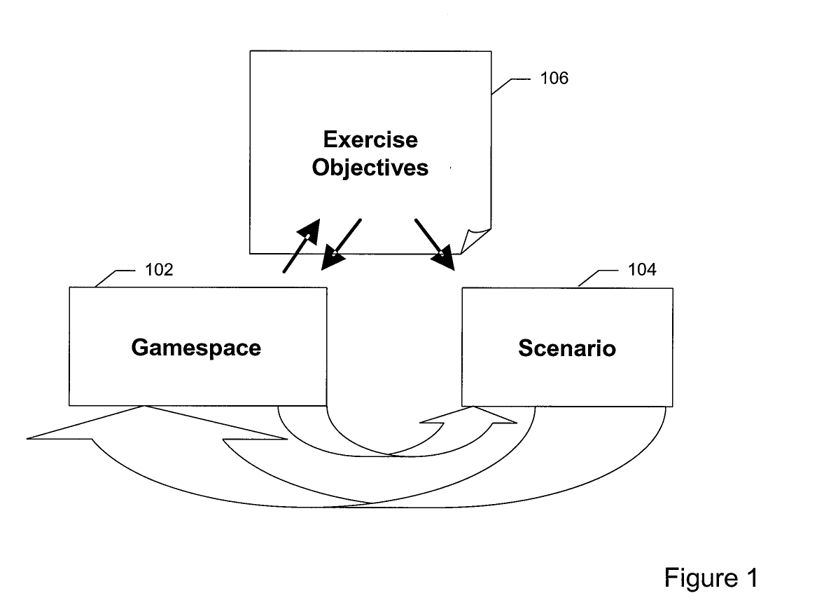

Typically, an exercise is an artificial or semi-artificial event whose purpose is to teach by drawing lessons about which real-world practices work well, and which do not, before these practices are exposed to real world events. Simply put, an exercise allows for the evaluation of a subject, such as a corporate or government infrastructure, without exposing that infrastructure to damages that may be caused by real world events. Because of this, structured and well planned operational exercises can be very valuable tools in assessing the strengths and weaknesses of an entity. These simulated real world exercise events (e.g., non-cyber-space events) are typically played out within a simplified model of reality which may be referred to as the “game space,” wherein the game space may be designed to meet general and/or specific objectives. Events within this game space are typically shaped and paced by a predetermined scenario, which may both prompt and bound the exercise outcomes. Referring to FIG. 1, exercise design practices involve the creation of the game space 102 and the scenario 104, both of which may be mutually dependent on one another in a way that satisfies the exercise objectives 106 of each participant.

Unfortunately however, exercise and scenario development, for both real world and cyber world events, are rarely simple tasks. This is because as the complexity of the event increases, so does the complexity of generating the game space 102. This is particularly true for cyber world events. The complexity of creating a cyber game space 102 is typically driven by the format of the exercise and the number of stakeholders, or participants, involved, wherein the cyber game space 102 may be defined by any number of parameters, such as the format of the exercise, the number of enterprises participating and the player roster for each enterprise, the roles that these enterprises play in the exercise, the data transactions that occur and the network topologies on which they occur and the plans, policies and procedures of the participants. Moreover, cyber exercises tend to be more complex than other incident response exercises because the scope of most incident response exercises is defined by the geographical limits of the disaster effects, while cyber incidents occur “in the wild” in a game space 102 that is infinitely complex and whose boundaries are practically unknowable. In fact, because it can many months to plan such an exercise, the participant group(s) may radically change due to operational commitments and/or player concerns for risk.

In this type of dynamic environment, exercise scenario development becomes a highly iterative process. The present method supports this iterative process by allowing scenario designers to collaborate, save and edit their work, validate developed scenarios 104 and present intermediate scenario planning products to sponsors and participants as the exercise development and implementation proceeds.

A method for creating a robust exercise scenario 104 for evaluating an organization is described herein as being implemented via a Cyber Exercise Scenario Design Tool (CESDT). The CESDT provides a structured and rigorous environment in which information responsive to single and/or multiple participants can be used to develop an exercise scenario 104. To accomplish this, the CESDT may prompt users with carefully conceived assessment questions, guide them through a sequenced and structured process, organize their activities and outputs, and support collaboration in a secure and/or unsecure environment. It should be appreciated that although the method of the present system is disclosed herein as being implemented via the CESDT, the method may be practiced in any manner suitable to the desired end purpose.

Generally, the formal exercise design process as outlined in the Homeland Security Exercise & Evaluation Program (HSEEP) is structured to help planners manage the complexity associated with exercise development. The HSEEP helps to reduce the risk of failure and is a valuable guide for exercise generation. Unfortunately however, it is intended specifically for community emergency response exercises, which tend to be simpler by comparison to cyber exercises, in part because they are typically based on well-developed response doctrines. Because cyber exercises typically require a much more extensive discovery process and game space development, the HSEEP is typically not a sufficient guide for cyber exercise development. However, because the method of the present system is applicable to essentially all areas, including Federal, State and Local government agencies that are accustomed to the process, the present system includes operational phases that may be aligned with the HSEEP milestones, wherein the operational phases include: Concept & Objectives Phase, Initial Planning Phase, Main Planning Phase and Final Planning Phase. It should be noted that although the method of the present system is discussed herein as being aligned with the HSEEP, the method of the present system does not have to be aligned with the HSEEP.

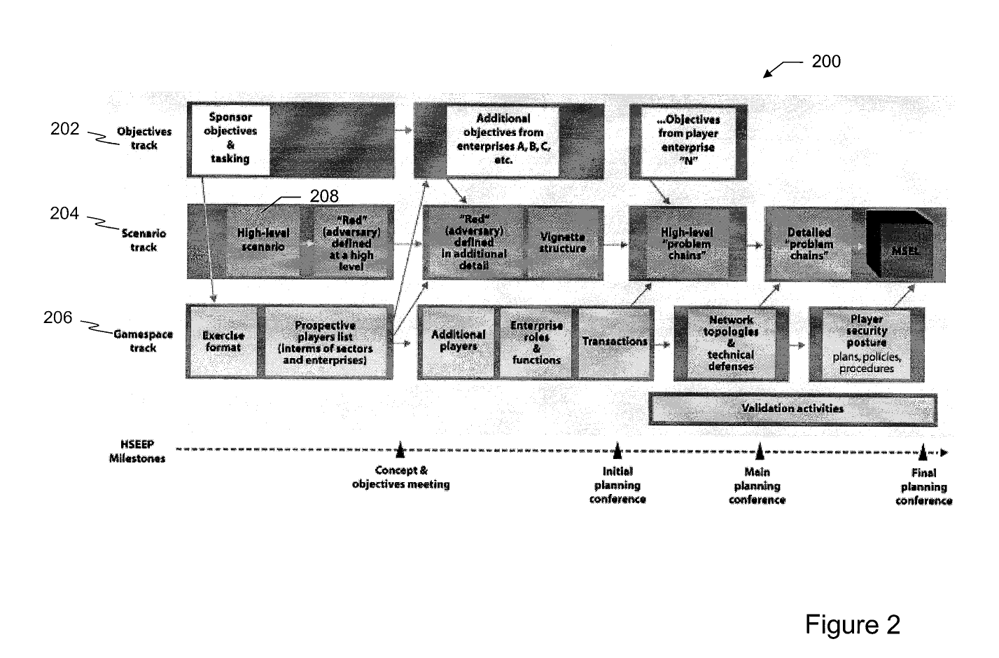

Referring to FIG. 2, a block diagram illustrating one embodiment of a method 200 for evaluating an organization is shown. The method 200 includes a plurality of parallel planning tracks: the Objective Track 202, the Scenario Track 204 and the Gamespace Track 206, each of which are discussed with regards to the operational phases in greater detail hereinafter. The Objectives track 202 involves defining the objectives of the exercise being designed. This may be accomplished by conducting an initial assessment to obtain information about the purpose of the exercise. For example, who is to be involved in the exercise and who is to make the decisions (i.e. Decision Authority) during the exercise may be assessed. In some situations, it is contemplated that the Decision Authority may be the authority that will define the objectives 106 (either partially or wholly) for the exercise.

The Scenario track 204 involves defining the scenario elements for the exercise. Some scenario elements may include defining the thresholds for the scenario, defining the levels of attack, defining the source of the attack and defining the level of decision maker within the organizations involved that will be engaged during the attack. The Gamespace track 206 involves defining the gamespace 102 for the exercise. This may be accomplished by identifying characteristics of the exercise. For example, some characteristics may include the duration and format of the exercise, the participants to be involved with the exercise, the level of involvement of each participant, the level of interaction between the participants and whether the actions of the certain participants will be scripted and/or unscripted.

Concept and Objectives Phase

The development of effective scenarios is a constituent part of the overall exercise design. Typically, the exercise design process begins by defining the concept and objectives of the exercise. Thus, the method 200 may begin with this phase as well. Many of the outputs of this phase of a scenario planning process are of a general nature and are typically not suitable for inclusion in database tables. Rather, they are captured in documents, spreadsheets, or briefings and archived in a project document repository for reference by the scenario developers. It is contemplated that the scenario development team, in an effort to build stakeholder support, will begin populating the CESDT tool with drafts of scenario products and/or data as early in the process as they deem necessary and wise. It should be appreciated that the flexibility of the CESDT may allow collaboration and sharing of draft documents as early as possible, such as the concept and objectives meeting.

At this operational phase, exercise scenario objectives 106 should be clearly defined and the scenario developers should be thoroughly familiar with those objectives 106. This may be accomplished by defining a decision authority and obtaining information regarding desired objectives 106, wherein the decision authority is the highest person in the sponsoring organization's leadership who will define objectives 106 for the exercise. It should be appreciated that the decision authority, who may be several levels senior to the director of the exercise, ultimately decides whether or not the exercise and its scenarios are successful. Thus, some initial questions may include: Who is the exercise decision authority?, and What are the decision authority's objectives 106 for the exercise? Answers to these initial assessment questions may be in the form of a tasking statement from a sponsor and may include initial input within the objectives track 202, wherein the tasking statement enables the creation of a High-level Scenario 208.

The creation of the High-level Scenario 208, which may either be mandated by the decision authority or proposed by the scenario developer and approved, should consider a variety of factors necessary for exercise development. As such, some additional assessment questions may include:
1) Should the scenario cross a particular threshold (e.g. constitute an “incident of national significance” or put at-risk a certain enterprise operation)?;
2) Is the cyber scenario meant to be a stand-alone event, or is it meant as a force multiplier for a set of attacks?;
3) Is there a desired attack source (e.g. nation-state, sub-national terrorist organization, organized criminal element, lone wolf, insider, etc.);
4) Should the cyber scenario include attack attribution to a particular actor or set of actors?; and/or,
5) What level of decision maker within the player organizations should the scenario engage?

At this point, a distinction between the events that will unfold in the exercise and the manner in which the participants will develop situational awareness of the events may be introduced. This is because typically objectives cannot be fully satisfied if the participants unrealistically have advance knowledge of “ground truth” (i.e. the events that will unfold) which would provide them with situational awareness they would not have in a real situation. As such, exercise designers want the participants to develop situational awareness based only on the observable effects of the cyber attacks, rather than give the participants unrealistic situational awareness about the nature or origin of the attacks. The method 200 groups ground truth events into “problem chains” which result in observable effects that make up a Master Scenario Event List (MSEL), wherein the MSEL events may also be referred to as “injects” and may be distributed as desired to stimulate players to respond during the exercise. The exercise controllers may use ground truth scenarios during the exercise to respond to player questions or actions in a consistent manner, wherein the ground truth scenarios may also serve as the primary source document for production of the MSEL list.

The scenario developer should obtain sufficient information from the high-level scenario 208 to define some characteristics of the attacker or “red team” (RED). As such, as RED is being defined, some assessment questions may include:
1) Who is RED?;
2) What are RED's objectives (why is RED attacking, and what goal must RED achieve to be successful)?;
3) What capabilities does RED have, including resources, technical ability and attack tools (weapons)?;
4) How is RED organized (if more than a single individual)?; and
5) What is RED's timeline for achieving its objectives?.
   The answers to these types of questions will allow the scenario designer to develop a game plan for RED that will guide the delineation of specific attacks against specific targets. This game plan, which may be documented at this point in the exercise design, will become part of the ground truth scenario, as discussed hereinabove, which may be used by controllers as a guideline for responding to player requests for information, as well as for creating new scenario injects (MSEL items) as needed during the exercise.

FIG. 2 illustrates how the gamespace 102 may be built and how the gamespace 102 may relate to scenario development and definition of exercise objectives 100. It should be appreciated that a cyber scenario 104 preferably takes into account how the scenario 104 will be played out in the gamespace 102. As such, the method 200 reinforces the close collaboration between the scenario developer, who is ultimately responsible for the scenario track 204, and the scenario developer's functional counterpart, referred to as the “gamespace designer,” who is responsible for the gamespace track 206. Some initial inputs that may be needed to define the gamespace 102 may include the duration and format of the exercise and the prospective list of organizations and players who will participate in the exercise.

It should be appreciated that the exercise format may vary with respect to the degree to which players will be immersed in the exercise experience. For example, at one end of the spectrum is a tabletop exercise where players may sit in a conference room and receive “white card” injects to stimulate a discussion. Whereas, at the other end of the spectrum is an immersive full-scale exercise in which players distributed among many enterprises and/or organizations react to complex scenario events unfolding in a realistic manner. It should be expected that the choice of exercise format may, at least partially, drive the cost, complexity and/or schedule of scenario development. Thus, planners should know in advance whether the exercise is to be a two-sided exercise (with opposing teams each able to act independently of one another), a one-sided exercise (with scripted events defining the actions a single team will take), or some variation.

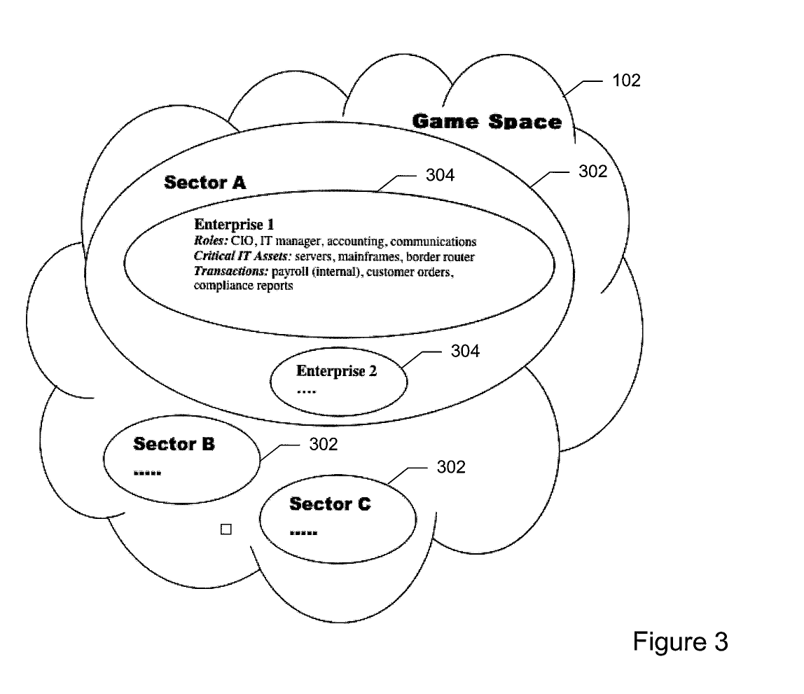

The prospective list of organizations and players who will participate in the exercise will most likely impact the scenario development. Turning to FIG. 3, depending upon the decision authority's intent for the size and scope of the exercise, as well as the level of specificity in his tasking and objectives, players may initially be defined in terms of sectors 302 (e.g. Finance, Energy, Telecommunications, Transportation, etc), as well as in terms of enterprises 304. In some cases, the basic building block used to define a gamespace 102 for cyber exercises may be an enterprise 304, either private or public (e.g., government). Moreover, most enterprises 304 operate (or have business elements that operate) within a particular sector 302, which may be viewed as a grouping of enterprises 304 (business, industry groups, government agencies) that share a similar function or role in the economy. It should be appreciated that the scenarios may include enterprises 304 from only one group or sector 302 or the scenarios may include enterprises 304 from across multiple sectors 302. Although, the attributes of each enterprise 304 within a sector 302 may eventually be defined in detail sufficiently enough to support the exercise objectives 106, at this stage it may be sufficient to simply identify high-level attributes of the prospective enterprises 304, wherein one embodiment of the relationship of enterprises 304 to sectors 302 within the gamespace 102 is illustrated in FIG. 3. At this point, some assessment questions may include:
1) Does the decision authority have any expectations for exercise type (format) and duration?; and
2) Does the decision authority have a proposed player list?

At this point in the development of the exercise, a base definition of the exercise, including a high-level scenario and definition of the adversary (a.k.a. “RED”), is known and the scenario design team is typically ready to participate in an exercise concept and objective meeting to determine if the development is ready to go to the next level. As such, the products of the tasks discussed hereinbefore may be presented (in presentation and/or written format) and the result of the meeting may be a consensus as to whether to proceed to the next phase.

Initial Planning Phase

At this point in the development of the exercise, the scenario design team is typically able to add more definition to its required products, with the goal of preparing for an Initial Planning Conference. It should be appreciated that, as the exercise design evolves, the gamespace 102 may expand to include more player organizations. One reason for this is that in order to satisfy the sponsoring organizations objectives 106, many enterprises 304 and organizations may have to participate in the exercise. Most of these player organizations may participate on a volunteer basis, but they probably will expect some benefit from their participation. As such, the objectives 106 of these additional enterprises 304 and organizations must also be considered and satisfied. However, up to this point, only the objectives 106 of the sponsoring organization have been discussed.

To satisfy play objectives 106, the exercise may have to be expanded to include additional entities (examples include additional ISP's, managed security providers, regulatory agencies or local government agencies). Thus, the gamespace 102 may be a very dynamic environment, where the mix of participating organizations may change over time, in which the scenario developer must build a scenario that satisfies all players in the gamespace 102 even as it changes. As such, as shown in FIG. 2, the next task on the gamespace track 206 may be to identify any necessary additional players and the next task on the objectives track 202 may be to identify any additional objectives added by the additional players.

After player organizations have committed to participation and have defined their objectives 106, the organization of the scenario development team should become clear. It should be appreciated that because it is often difficult to understand player roles and relationships vital to the exercise without inside knowledge of one or more players, it is likely that the team will benefit from close collaboration with “trusted agents.” These trusted agents may be individuals within player organizations that are designated to ensure their objectives are met, the scenario is realistic and their concerns for risk associated with participating are managed quickly, efficiently and effectively.

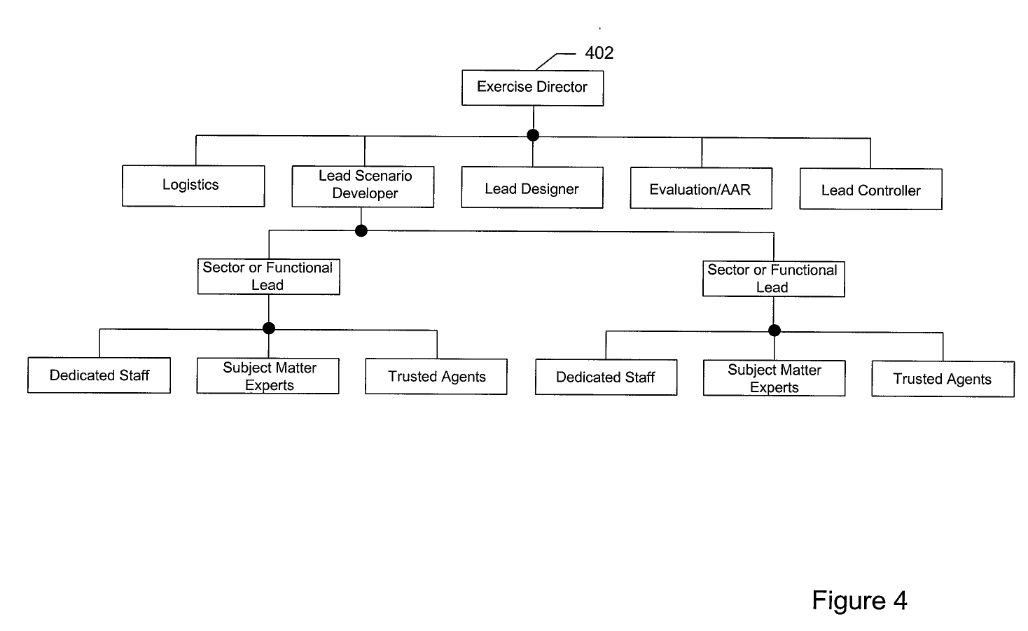

Referring to FIG. 4, it is contemplated that for larger exercises, an exercise director 402 may define a team that includes individuals responsible for exercise design, scenario development, logistics, evaluation/after-action review and control. It is worth noting that the method 200 provides for an CESDT that may be designed to support a scenario development organization of any size and structure.

As player organizations agree to participate, the gamespace 104 becomes further defined in terms of the function each player (organization and individual) performs. Some assessment questions that may help the scenario developer to understand the gamespace 104, leading to an initial understanding of the organizational or transactional weaknesses that a scenario might expose, may include:
1) What level(s) of decision-maker should participate to accomplish the sponsoring agency's objectives 106? (This is because understanding the level of decision-maker playing in the exercise is an important input to scenario development. Some objectives 106 may imply the need for players who will make strategic (front-office) decisions. Other objectives 106 may imply the need for tactical (network-level) decisions. In some cases, objectives 106 may imply the need for player decisions at the level of an enterprise risk manager or business continuity manager);
2) In order to accomplish the exercise objectives 106 will more than a single enterprise 304 participate?;
3) If objectives 106 require the participation of only a single enterprise 304, what types of functional (roles) within the enterprise 304 should be represented to accomplish the sponsor's objectives 106?;
4) If the sponsoring agency's objectives 106 require more than one enterprise 304, what types of enterprises 304 should participate to meet those objectives 106?;
5) What are the key business roles that each enterprise 304, business element, or sector 302 will perform within the exercise?;
6) What are the key player roles within each enterprise 304? (Player roles may include business continuity manager, chief information officer, public information officer, etc. Player roles may also make up a simplified organization chart based on specific roles that will participate in the exercise); and
7) Within the exercise, what are the vital relationships between these enterprises 304, business elements and/or sectors 302?

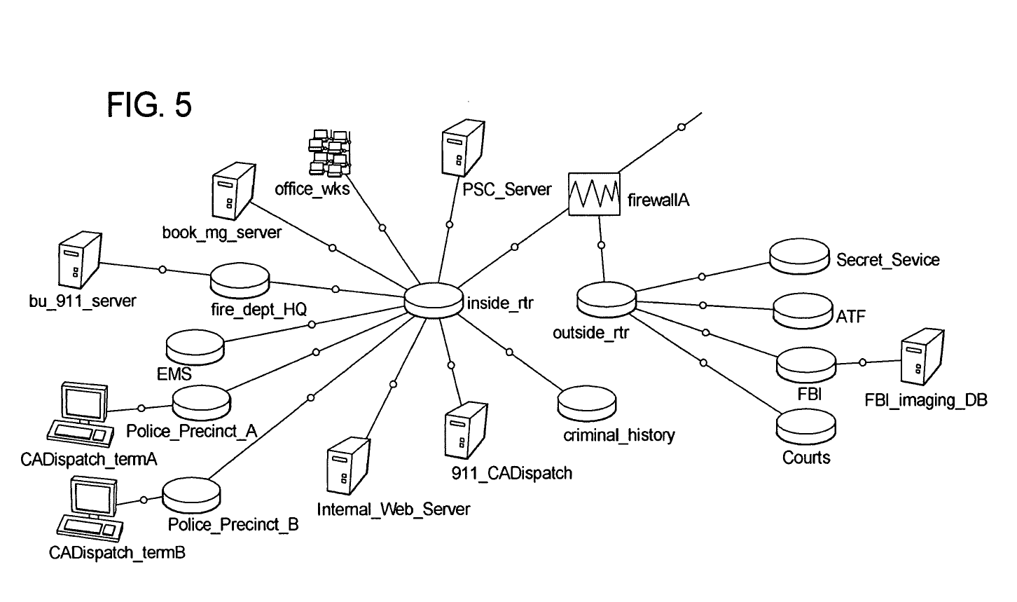

Referring to FIG. 5, in some cases the team may want to understand how the scenario should support the “major muscle movements” of the exercise. One way to accomplish is to divide the exercise schedule into a series of vignettes or major cycles of player activity.

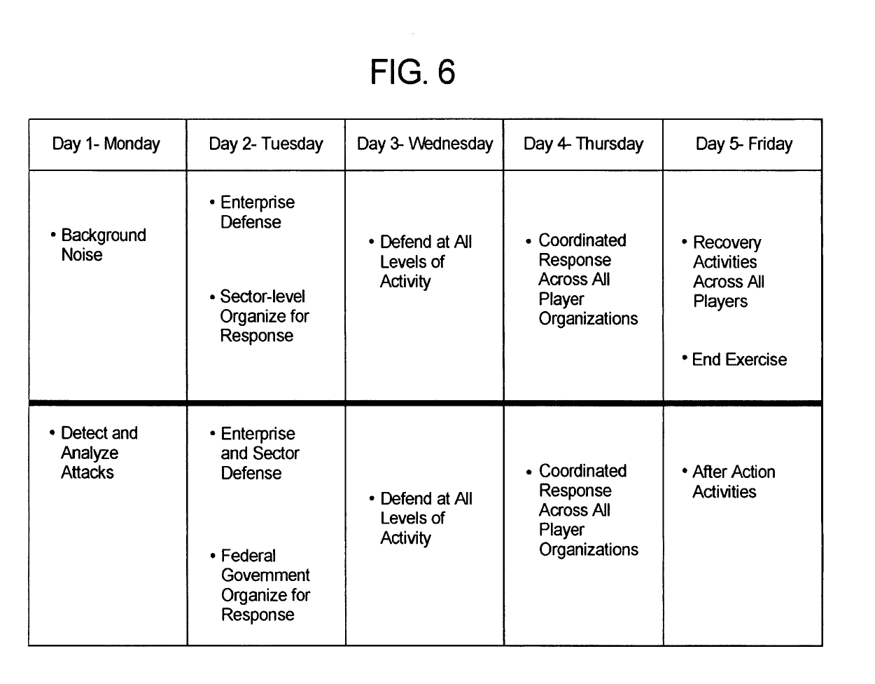

For example, referring to FIG. 6, the decision authority has mandated a five-day, one week exercise that may begin on Monday, end on Friday and include two player sessions per day—one in the morning and one in the afternoon. In this example, the exercise director may determine that in order to meet the sponsor objectives 100, there should be at least five (5) major cycles of player activity, organized into at least seven (7) different vignettes, wherein the five (5) cycles of activity may include ‘detect and analyze’, ‘organize for coordinated defense’, defend, respond, and recover. Furthermore, in order to support a credible series of ‘detect and analyze’ activity, it may be determined that the exercise should begin with “background noise” activities that make it difficult to distinguish between routine network activity and indications of a coordinated attack.

It should be appreciated that defining desired cycles of player activity at this level may allow the scenario designer to better understand the types of activities that his scenario should or must support in order to keep all players engaged throughout the exercise and to meet the objectives 106 of the players and sponsors. In order to accomplish this one assessment question may include “What major cycles of player activity does the decision authority expect to see (e.g., deter and prevent, detect, defend, respond, recover, etc.)? At this stage, an initial planning conference may be conducted where products of the tasks that have been discussed hereinbefore are evaluated and approved, wherein many of the products of the defined tasks may still be in briefings or text documents. Once the decision authority and any other relevant stakeholders have approved the above, the team may be ready to proceed on to the detailed planning phase where the databases of the CESDT may be populated with the details of the gamespace 102 and scenario 104.

Main Planning Phase

At this point, the next steps in the cyber exercise design process may require a more thorough understanding of how the IP-based data transactions between players are defined within the gamespace 102. It is contemplated that approved outputs of the initial planning conference will become the basis for the initiation of a new project in the CESDT and thus, the person responsible for creating this new scenario project within the CESDT will:
1) Establish a project within the CESDT for the new exercise;
2) Grant privileges to members of the scenario design team (including Trusted Agents as necessary);
3) Establish the identities and/or aliases of the initial list of participants;
4) Populate a library for this exercise with key references; and
5) Allow the scenario designers to begin inputting the known attributes of the enterprises 304 and players.

At this point, however, the gamespace 102 should be defined further. A transaction is an exchange between two (2) or more entities that stimulates specific action on the part of one or more of those entities that relates to mutually dependent organizational functions or activities. Some types of transactions may include exchange of goods or services, validation or approval of activities, transfer of value or currency and/or sharing of data or information. As players, their roles and their objective become clearer, the scenario development team should attempt to define IP-based data transactions that support the roles these players will perform in their exercise. Some examples of transactions include: purchase of parts or raw materials by a manufacturer from a supplier, ordering of merchandise from a vendor by a retail distributor, requests for services or capabilities by a customer from a utility entity, electrical transmission, water and gas distribution to users, disclosure of activities for review by a validation or regulatory entity, purchase, sale, or trade of shares, futures, bonds, other equity in a financial market, requests for services involving response by a public entity (investigative, law enforcement, public safety and emergency response organizations; local, municipal, regional, state, or federal government service entities) and collaboration between entities with common interests for the purpose of problem-solving and self-regulation (ISACs and professional organizations in a business sector analyzing threats and dangers common to their entities; disaster-recovery exchanges sharing response and mitigation measures; energy production and distribution firms determining load and pricing data).

Furthermore, transactions may be internal or external, wherein internal transactions that are critical to business continuity may include payroll and accounting. Enterprises 304 within a sector 302 often interact with each other through a series of transactions that may include requests for goods or services, reporting, and transfer of funds. In some cases, transactions may cross sector boundaries and involve enterprises 304 from two or more sectors 302. It should be appreciated that the degree of detail in which these transactions need to be captured may depend on the objectives 106 of the exercise, but they may also be defined because they provide a critical mapping between the RED team objectives and the attack scenario. Some assessment questions that may be useful for understanding how IP-based transactions as defined in the gamespace 102 may affect the scenario 104 may include:
1) What key transactions and communications support the player-defined roles and relationships (both internally and between entities)?; and
2) Which of these key transactions are IP-based (therefore might be subject to first-order disruption from a cyber attack)?
   Scenario designers may use the answers to these questions to begin populating a table in the CESDT database.

At this point, the definition of participating player organizations, their objectives 106, roles, relationships and an understanding of how transactions support those relationships within the gamespace 102 is typically sufficient to allow for iteratively defining of additional detail about RED and its attack plan. To accomplish this, some useful assessment questions may include:
1) Within the gamespace 102, as it is currently defined (including sectors 302, enterprises 304, roles, communications, and IP-based transactions), what targets must red attack to achieve his objectives?;
2) What steps must Red take to “prepare the battlefield” in order to achieve its strategic attack objectives (Consider such things as prepositioning attack tools, developing zero-day exploits, testing to ensure Red's tools, tactics, and strategies will work as planned)?;
3) What steps will Red take to remain anonymous (assuming Red desires to deter a response by keeping the defender from easily attributing the source of attacks)?;
4) How will Red communicate (securely) prior to and during the attack?;
5) How will Red know if his attacks are successful?; and
6) What actions by Blue (the defending side in the exercise) would keep Red from accomplishing his goal or from launching planned attacks?
   Scenario developers may use the answers to these type of questions to begin populating the RED attack profile table in the CESDT database.

The ground truth scenario should be developed in enough detail to support the anticipated level of decision making in the exercise. It is worth noting that when immersed in an exercise, players will typically ask for information which they might reasonably know in order to take correct actions or make informed decisions. This is a normal part of the process of gaining situational awareness. In practical terms, it may mean that scenario definitions should include a level of detail below that at which players may make decisions so that enough information exists from which controllers may realistically satisfy player requests for information. Starting from a strategic perspective of the scenario, and working through an iterative process to fill in tactical detail, one useful way to think involves thinking in terms of discrete “problem chains.” We define this term as a unique problem intended to stimulate a decision and/or response from one or more players. Some examples of problem chains might include: disruption of money supplies, extorting an enterprise with on-line denial of service or data disruption, domain name server spoofing, destruction of an internet hotel, disrupting VoIP communications, and/or destroying a key value chain in one or more sectors. It is worth noting that each of the above problem chains is defined at a fairly high level. The method 100 calls for first defining problem chains at this level for several reasons. One of these reasons is to begin mapping scenario elements against specific players in the exercise.

By defining problem chains at higher-levels, the scenario designer can more easily map specific scenario elements to one or more participating enterprises 304 (or business elements) and their objectives 106. For example, “destruction of an internet hotel” may be a single scenario element that might satisfy objectives for multiple players such as an ISP, a local government, one or more enterprises in a geographic region, and Federal responders. Likewise, “disruption of money supply” might easily map to every player in an exercise that deals with the finance sector, as well as security providers, regulators, and other government entities. High-level problem chains may also serve as useful mechanisms for the scenario designer to communicate the scenario 104 to all stakeholders and receive quick feedback about their satisfaction with it. Mapping of high-level problem chains to the vignette execution schedule, as well as to sectors 302, enterprises 304, and individual objectives, is typically easy to accomplish and problem chains are typically easy to reference, visualize, and communicate in stakeholder briefings.

The CESDT may provide an editor that helps to guide the scenario designer through the process of mapping high-level problem chains to the enterprises 304 and objectives 106 that have been previously defined in the gamespace tables, wherein the process may create records in the high-level problem chain table. It should appreciated that there may be additional benefits to defining high-level problem chains. One such benefit is that these become separable scenario elements that can be independently developed. The software development analogy to problem chains is the use of object-oriented programming rather than developing spaghetti code. If one problem chain isn't coming together, must be discarded, or requires major re-write due to gamespace changes, this should not have a major impact on the entire scenario. Another such benefit is that when it comes time for exercise execution, controllers managing the MSEL may have the flexibility to discard entire scenario elements if necessary, rather than have to sort through and delete individual injects or attacks.

As such, the development of high-level problem chains should occur iteratively as the scenario development team, relying heavily on trusted agents, works through a process of discovery to understand the nuances of how IP-based data transactions may support that player's key roles and relationships with other players. It should be appreciated that even after the development of these high-level problem chains, it is still not too late for additional player organizations to commit their participation. Thus, problem chains can be added, deleted, or modified as desired and as the gamespace 102 develops over time, including the addition or deletion of participating enterprises 304. It is contemplated that depending on the exercise scale, scope, and complexity, it may be useful to establish a dedicated scenario working group to define and integrate how common scenario elements, such as high-level problem chains may support each player individually, and the exercise as a whole. However, from a scenario development perspective, definition of high-level problem chains is typically sufficient progress to meet task requirements for a main planning conference (MPC) and outputs from the CESDT database may be used as the basis for many aspects of the conference.

Final Planning Phase

At this point, the team should now elaborate the high-level problem chains into more detailed problem chains. In order to accomplish this, they should further define the gamespace 102 to provide the supporting detail that will make the scenario 104 credible and engaging. A high-level problem chain may include one or more discrete, sequenced attacks. For example, “destruction of an internet hotel” might include a single physical attack using a large bomb. Conversely, a problem chain such as “destruction of a key value chain in the manufacturing sector” may include dozens of discrete, sequenced, and coordinated cyber attacks, each aimed at disrupting a particular enterprise, a role, set of transactions, or system(s). The term “detailed problem chains” refers to scenario elements that have been defined at this lower level of detail (in terms of discrete attacks).

In order to create detailed problem chains, a more detailed understanding of the gamespace 102 may be required. This level of scenario definition often may not be accomplished without defining (e.g., mapping) key data transactions to critical IT assets such as servers, routers, workstations, mainframes, and the “pipes” that connect them. The scenario development team may define representative network topologies for each enterprise whose objectives require the creation of credible and technically detailed scenario injects as part of the MSEL. Network topologies may be used to graphically illustrate the relationships between enterprises 304 and the operational view of the IT infrastructure within an enterprise 304 and each enterprise 304 within a sector 302 may have a network topology representing its IT infrastructure, which may include interconnected nodes of critical IT assets (routers, servers, workstations, etc.). Well-defined topologies make the gamespace 102 more authentic and allow scenario designers to create a more compelling and immersive scenario 104.

Typically, the scenario developers may work with members of the gamespace design team to build representative network topologies using an application with the CESDT, such as HP Open View, which may allow for the graphical representation of network topologies and traffic flows. In the process, they may populate the Network Device table in the CESDT database with the detailed information about network topologies and may map transactions from the Transactions table to specific IT assets. As the detailed problem chains are constructed, they may be allowed to choose the specific transactions and IT assets that may be affected from those they have defined in these tables. This constrains the developers and prevents them from constructing a ground truth scenario that will be illogical in terms of the defined gamespace 102.

It should be appreciated that scenario developers should understand, to some level of abstraction, the technical defenses that protect the network topologies defined above, such as intrusion detection systems, firewalls, honeypots, etc. Scenario developers may use menus (such as pull-down menus) to populate the security posture table with information about the specific tools available to each enterprise and the frequency with which these are employed, as well as any other information determined to be significant for the desired end purpose. Moreover, scenario developers may investigate policies, procedures, and plans from participant enterprises 304 in order to understand the likely responses to exercise events. These plans, policies, and procedures may vary greatly in format and detail from one organization to the next and, as such, it may not always be possible to propose a strict mapping from plans, policies, and procedures to expected player actions with respect to specific scenarios.

It should be appreciated that the proposed system allow plans, policies, and procedures to be documented and referenced by scenario developers without specific inclusion in the direct chain from objectives 106 to problem chains to MSEL. Some useful assessment question may include:
1) What plans, policies and procedures governs the security of the key transactions and data?;
2) What IT security assets are available?;
3) What indicators are watched?;
4) With what periodicity are these indicators reviewed?;
5) How do you problems typically discovered?;
6) How are problems/indications of disruption communicated?;
7) What is the path for escalating problems?; and
8) What are the thresholds for reporting problems to more senior levels?
   It is contemplated that the CESDT may prompt scenario planners to compare a player organization's required transactions, both internal and external, against their security posture in order to find seams that should be exploited in the scenario. It may also prompt them to ensure that Detailed Problem Chains are designed to expose these seams to players during the exercise. To accomplish this, some assessment questions useful for understanding the gamespace 102 in sufficient detail to develop specific credible attacks (detailed problem chains) may include:
1) What are the sources and destinations of key transactions (defined in terms of the servers?)?;
2) What is the normal frequency range within which these transactions occur?;
3) Does this range typically vary over time (by hour, day, week, month)? If so, how?;
4) What is the vital data content that supports this transaction?;
5) Where in the process is that data added to the transaction?;
6) Does this data come from an internal or external source?;
7) How is its integrity maintained?;
8) What communications normally occur in support of these transactions?; and
9) What IT assets support these transactions (think in terms of hardware, software, and people)?

It is contemplated that at this point the gamespace tables may be populated with the complete list of sectors 302, enterprises 304, and players, their roles and transactions, and the network topologies and IT assets they may use to perform transactions. The gamespace tables may also contain the “security posture” of each enterprise 304, that is, the technical defenses and plans, policies, and procedures that define how and when each enterprise 304 will perceive events as they unfold. With the gamespace 102 defined, the scenario developers may proceed to define the detailed problem chains. Within the CESDT tool, each developer may call up a specific high-level problem chain and, using a series of menus (such as pull-down menus), construct the detailed sequence in which RED will attack each enterprise. They will map out which transactions may be disrupted and which IT assets those transactions rely upon. Using the player roles and security postures in the database, they can determine how the events will be detected by the players. In some cases, they may plan events that will not be detected, because the player profiles may have no provisions for timely detection. Also, using the player roles and security postures in the database, scenario developers can anticipate the expected responses of the players.

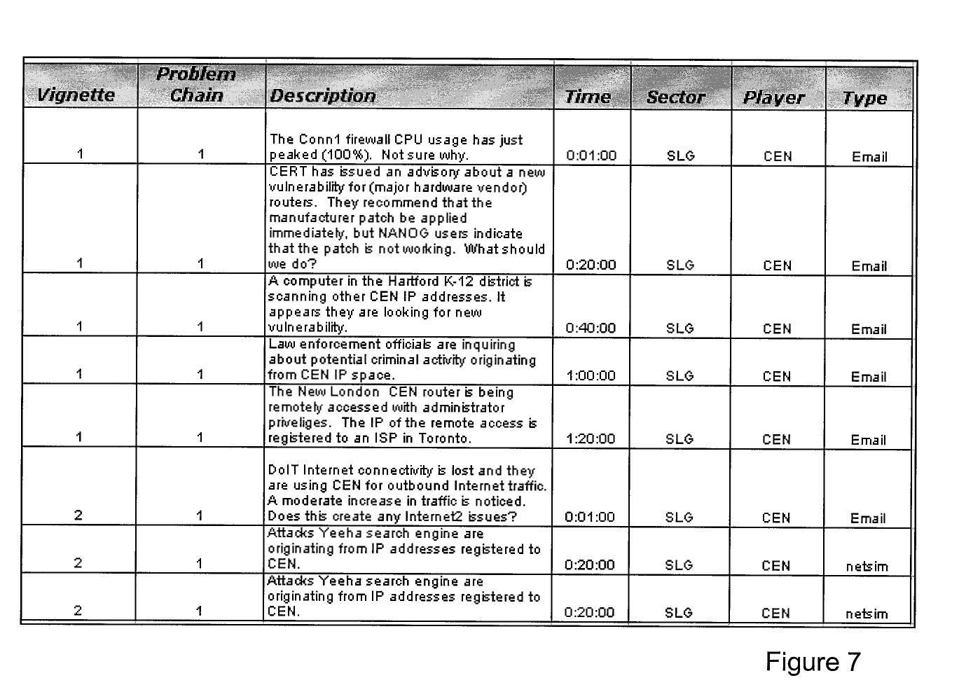

Referring to FIG. 7, scenario developers may now be able to link events into problem chains using predecessor/successor fields for each event. These may allow multiple entries and include logic (such as if—then logic) to provide for branching scenarios in which future events may depend on player choices or other events. It is contemplated that, in the process of defining detailed problem chains, scenario developers may be constrained by the information that exists in the gamespace 102 to prevent them from constructing “illogical” scenarios. However, there may be some situations in which these constraints may be removable. The outcome of this may be a set of detailed problem chains linked to high-level problem chains, which are in turn linked to the objectives in the objectives table. These detailed problem chains may then be linked to specific MSEL events as described hereinafter. Taken together, and in concert with the high-level scenario and the definition of RED, these detailed problem chains may make up the ground truth scenario. They can be printed, bound into a manual, and distributed to the control team for use during the exercise, or they can easily be referenced electronically through a web interface or integrated into an application designed to support controller/evaluator functions during a cyber exercise.

It should be appreciated that it is often important to distinguish between “ground truth” events and observable effects in an exercise, since players should typically only see events as they would be revealed in a real situation (e.g., through help-desk complaints, intrusion detection systems, etc). The translation of ground truth to observable effect is the final process leading to the creation of the Master Scenario Events List (MSEL), which may be a time-stamped database of observable events presented to the players—either by hand or by some exercise execution engine. A single attack by RED may lead to multiple “observable” events, each of which may be delayed from the time of the actual attack. The scenario development team, perhaps working with outside experts, should attempt to qualitatively validate individual MSEL items to ensure that the players' situational awareness during the exercise, as determined by the injects received (in addition to efforts they make to communicate), are deemed credible. The method 200 and the scenario products that derive from the method 200, both support such a qualitative review, which in turn may benefit from many of the validation tools propose herein.

It should be appreciated that the MSEL is actually a time-sequenced list of observable effects of the attacks contained within the detailed problem chains. What is observable to one player enterprise may be much different to another player enterprise, depending upon their respective security postures. The MSEL defines not only the observable effect of a particular attack by a player, and by time, but also by the method that the event would be observed based on the information defined in the gamespace 106. Additionally, the MSEL table may contain an optional field for “expected player actions,” given that individual MSEL events (observables) are stimuli to players which may have an expected response. Expected player actions may be important to the exercise execution phase because they allow the control team to track the “situational awareness” of a particular player or organization. A team that diverges significantly from expected player actions may be operating under false assumptions, requiring remediation on the part of the exercise controllers. Expected player actions are generally derived from plans, policies, and procedures, but in some cases plans, policies and procedures may not provide sufficient information to forecast such actions. For complex exercises this qualitative review would likely occur during a dedicated conference attended by all members of a scenario working group.

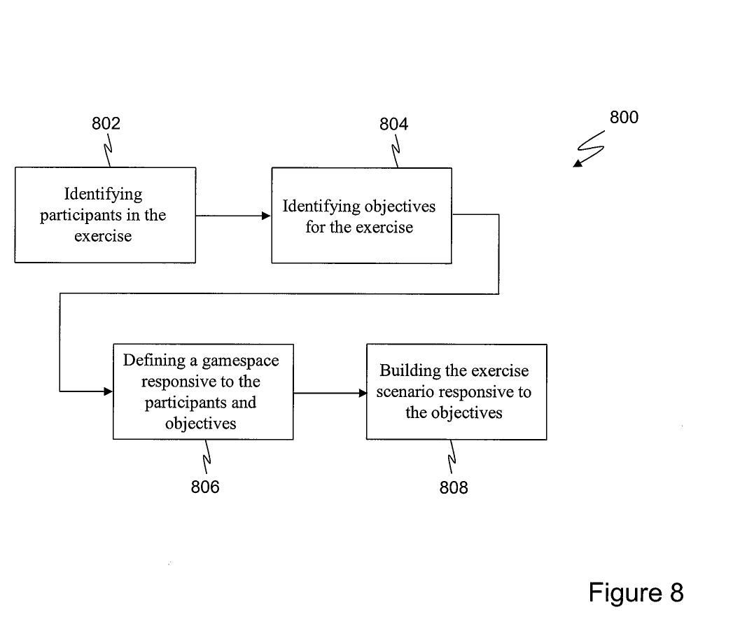

Referring to FIG. 8, a block diagram illustrating one embodiment of a method 800 for developing and implementing an exercise scenario used to evaluate an organization is shown. The method 800 includes identifying the participants in the exercise, as shown in operational block 2802. As discussed hereinbefore, this may include identifying an exercise designer, a decision authority and trusted agents which are typically representatives from each of the participating entities. The method 200 further includes identifying the objectives 106 for the exercise, as shown in operational block 804. This may be accomplished by each member identifying the objectives 106 for their respective entities. For example these objectives 106 may include how to identify and stop an attack, how to respond to an attack and when and/or how to establish communications with law enforcement agencies. It should be appreciated that any objective 106 suitable to the desired end purpose may be identified and may be responsive to many factors, such as type of business, type of perceived threat, type of environment, type of perceived attacker, etc. Furthermore, the exercise designer and/or the designated authority may also define and/or identify objectives 106 for the exercise, such as objectives 106 that may be designed to evaluate the overall plan.

Moreover, the method 800 includes defining a gamespace 102 responsive to the participants and/or the objectives 106, as shown in operational block 806. Once the participants and the objectives 106 have been identified, the gamespace 102 may be defined and may include the components of the business that are important to the organization. For example, IT topologies which model the IT structure of the organizations involved may be defined in the gamespace 102. Another example may be transaction topologies which model the business or transaction actions of the organizations involved. Furthermore, the method 800 includes building the exercise scenario 104 responsive to the participants, objectives 106 and/or gamespace 102, as shown in operational block 808. This may be accomplished by first identifying the high-level problem chains and then the more detailed problem chains, as discussed hereinbefore. At this point, the master scenario events list (MSEL) may then be generated and the events may be distributed to the exercise participants at predetermined times during the exercise. The reaction of the participants to the events may then be analyzed to evaluate the organizations ability to survive an anomalous event. To aid in the understanding of the method 800, the method 800 is described herein in terms of examples. The first example is a relatively simple tabletop exercise for evaluating a business continuity plan of a mid-sized company and the second example is a more complex exercise for evaluating the ability of national organizations to withstand a coordinated attack.

### EXAMPLE SCENARIO NUMBER 1

One example of a method for creating a robust exercise scenario 104 for evaluating an organization is discussed hereinafter with regards to a mid-sized company that is experiencing a cyber attack. Specifically, the company has developed a business continuity plan and it wants to evaluate its plan against a cyber attack. To accomplish this, the company intends to conduct a tabletop exercise with several of its internal departments, such as the IT, accounting, security, etc. to rehearse and evaluate the plan. The exercise planning team includes an exercise designer, a vice-president (decision authority) and representatives (trusted agents) from each of the participating departments. As discussed hereinbefore, each member identifies objectives for their respective departments, wherein the objectives would typically include concerns of the individual departments, such as identifying and stopping an attack, cost tracking and communication with law enforcement agencies. Additionally, the exercise designer and vice president (decision authority) also identify objectives for the exercise, which might include evaluation of the business continuity plan for an attack on the information infrastructure of the company.

At this point, the planning team defines the gamespace 102 for the exercise, wherein the gamespace 102 may include two (2) major components: IT Topology and Transaction Topology. The IT Topology identifies the major hardware components in the company's IT infrastructure, including routers, workstations, servers and mainframes. The topology may be sketched as an interconnected series of IT nodes, wherein each node may be identified by several defining attributes, including its name, operating system, location, etc. The transaction topology identifies the critical business processes within the company that represent the daily business processes, such as personnel records, payroll, accounts payable, etc. The transaction topology may also refer to the IT topology by associating transactions with the IT nodes that are critical to the performance of such transactions.

The next step involves building an exercise scenario. At this point, the planning team begins building the exercise scenario 104 using the objectives already identified and the limitations of the gamespace they have already collectively defined. It should be appreciated that the exercise scenario 104 may be created in successively increasing levels of detail, beginning with high level problem chains. For example, in this case the team may identify three (3) high level problem chains:
1) External penetration of the company firewall by an external attacker;
2) Physical sabotage of the company's IT operations (possibly by an insider); and
3) Comprise of confidential information, such as employee records including social security number.

At this point, the detailed problem chains are identified, wherein the detailed problem chains ‘flesh out’ the high level problem chains in the form of actual attack descriptions. As discussed hereinbefore, the detailed problem chains describe the “ground truth” of the attacks and are directly related in a one-to-many relationship to the high-level problem chains. For example, consider the identified high-level problem chain of physical sabotage of the company's IT operations, wherein the following detailed problem chains may be identified and include:
1) Ethernet cables disconnected on several key machines;
2) Air conditioning units being disabled in server rooms to cause the machines to overheat; and/or
3) Routers being unplugged.

At this point, the final step in the development of the exercise scenario is the creation of the master scenario events list (MSEL). As discussed in greater detail hereinbefore, the scenario events are typically the observable effects of the attacks described in each of the detailed problem chains. The MSEL events, which may be time stamped, are presented to players in some form during the exercise to see how the players will react. This reaction will then be evaluated. In this case, the MSEL events are statements on “white cards.” For example, consider the detailed problem chain of the Ethernet cables being disconnected on several key machines. The MSEL events for this detailed problem chain may be as follows:
1) MSEL event 10:04 am—Users complain they cannot reach server X;
2) MSEL event 10:15 am—NOC says that four (4) servers are not responsive; and
3) MSEL event 10:34 am—System administrator reports that Ethernet cables in payroll department have been disconnected.

The reaction of the players to the MSEL events will help the participants to determine if the business continuity plan will work during a real world cyber attack.

### EXAMPLE SCENARIO NUMBER 2

Another example of a method for creating a robust exercise scenario 104 for evaluating an organization is discussed hereinafter with regards to a national organization. For example, assume that the Department of Homeland Security (DHS) is organizing a national cyber exercise to evaluate the level of national readiness during a coordinated cyber attack on critical infrastructures. The exercise planning team includes an exercise designer, a senior official from the National Cyber Security Division (NCSD) of DHS who acts as the decision authority and representatives (trusted agents) from each of the critical infrastructure participating in the exercise (energy, banking/finance, transportation). As the exercise planning process progresses, the exercise planning team grows to include representatives from the participating government agencies and private sector companies.

At this point, each member of the exercise planning team identifies the objectives for their respective infrastructure area. These objectives could include both infrastructure-specific objectives and issues of general concern, such as identifying communication and information sharing channels, interaction with government regulators, law enforcement and national security groups. The exercise designer an NCSD may also identify additional objectives for the exercise, such as the evaluation of the National Response Plan in the context of a cyber attack, the evaluation of private/public partnerships during a crisis, etc.

The exercise planning team may then define the gamespace for the exercise, which in this case may include a specification of all participating sectors, the participating organizations (public and private) within those sectors and the player roles for each participating organization. Again, in this case the gamespace includes two (2) major components: IT Topology and Transaction Topology. As before, the IT topology identifies the major hardware components in the IT infrastructure for each participating organization, including routers, workstations, servers and mainframes. It is contemplated that the IT topology can be simplified and represented so as to not expose vulnerabilities or proprietary information. The IT topologies may be modeled as interconnected IT node, wherein each node may be identified by defining attributes, such as name, operating system, location, etc. The transaction topology may identify the critical business processes within the organization, between organizations (i.e. business to business), and between sectors 304 (i.e. business to government reporting) that may represent daily transactions that make the infrastructures operate. Moreover, the transaction topology may also refer to the IT topology by associating transactions with the IT nodes that may be critical to the performance of such transactions.

At this point, the exercise planning team may begin to build a scenario 104 using the already identified objectives and the limitations of the gamespace that have been collectively defined. As before, the scenario 104 may be created in successively increasing levels of detail, beginning with high-level problem chains. For example, in this case the team may identify the following high level problem chains:
1) Sustained cyber attacks on SCADA facilities in the energy sector;
2) Corruption of banking transaction; and
3) Comprise of sensitive infrastructure protection information.

At this point, the detailed problem chains are identified, wherein the detailed problem chains ‘flesh out’ the high level problem chains in the form of actual attack descriptions. As discussed hereinbefore, the detailed problem chains describe the “ground truth” of the attacks and are directly related in a one-to-many relationship to the high-level problem chains. For example, consider the identified high-level problem chain of SCADA attacks in the energy sector, wherein the following detailed problem chains may be identified and include:
1) Remote attackers gain control of an oil distribution pipeline; and
2) Power transmission station in Ohio being shut down remotely.

At this point, the final step in the development of the exercise scenario 104 is the creation of the master scenario events list (MSEL) which is a list of scenario events that typically include the observable effects of the attacks described in each of the detailed problem chains. The MSEL events, which may be time stamped, are presented to players in some form during the exercise to see how the players will react. This reaction will then be evaluated. In this case, the MSEL events are statements on “white cards.” For example, consider the detailed problem chain of the power transmission station in Ohio being shut down remotely. The MSEL events for this detailed problem chain may be as follows:
1) MSEL event 9:21 am—ISO in Ohio reports an expected shutdown of the power transmission station; and
2) MSEL event 9:45 am—The news reports indicates that up to 20,000 customers are without power in the mid-west.
   The reaction of the participants to the MSEL events will help to determine if the level of national readiness during a coordinated cyber attack on critical infrastructures is sufficient to effectively handle a real world cyber attack.

It should be appreciated that the method of the present invention may or may not be embodied, in whole or in part, via software, firmware and/or hardware. Additionally, it should be appreciated that the method of the present invention may or may not be embodied, in whole or in part, via instruction using training manuals (i.e. text based materials), seminars, classes, and/or any other media suitable to the desired end purpose. Moreover, It should be appreciated that although the method of the present invention may be implemented, in whole or in part, via software, hardware, firmware and/or any combination thereof, it is also contemplated that the method of the present invention may also be implemented, in whole or in part, without the use of software, hardware, firmware and/or any combination thereof. For example, without the full or partial use of any software, hardware and/or firmware and/or with any combination thereof, but rather via instruction using PC based software and/or classroom instruction with text materials (i.e. books, pamphlets, handouts, tapes, optical media, etc.).

Referring to the examples hereinbefore, it should be appreciated that each of the elements of the present invention may be implemented in part, or in whole, as required by the specific scenario developed. Additionally, it is contemplated that each of the elements being implemented may be implemented in any order suitable to the desired end purpose. In accordance with an exemplary embodiment, the processing required to practice the method described herein, either in whole or in part, may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing. It should also be appreciated that the embodiments disclosed herein are for illustrative purposes only and include only some of the possible embodiments contemplated by the present invention.

Moreover, the system may be wholly or partially embodied in the form of a computer or controller implemented processes. The system may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the system. The system can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the system. When implemented on a general-purpose microprocessor the computer program code segments may configure the microprocessor to create specific logic circuits.

While the invention has been described with reference to exemplary embodiments, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method of producing an exercise scenario to evaluate an organization's readiness for a situational anomaly, the method comprising:
identifying a plurality of cyber elements for the exercise scenario;
identifying a plurality of participants for the exercise scenario;
identifying a plurality of objectives for the exercise scenario;
defining a gamespace for the cyber elements of the exercise scenario based on the plurality of participants and the plurality of objectives, the gamespace including an information technology topology and a transaction topology; and
executing a hierarchical process to develop the cyber elements of the exercise scenario based on the plurality of objectives, the hierarchical process including defining a high level problem chain, a detailed problem chain, and a master scenario events list, the high level problem chain including a plurality of high level problem descriptions, the detailed problem chain including a plurality of detailed problem descriptions for each of the high level problem descriptions, each detailed problem description including at least one general ground truth description and at least one general observable effect, and the master scenario events list including at least one of (i) a plurality of stimulation events for each of the detailed problem descriptions and (ii) a plurality of simulation events for each of the detailed problem descriptions, each event in the master scenario events list including at least one detailed ground truth description and at least one detailed observable effect.

2. The method of claim 1, further comprising:
distributing at least a portion of the master scenario events list; and
recording a plurality of reactions from the plurality of participants.

3. The method of claim 1, wherein the master scenario events list includes a timestamp for each of the simulation events.

4. The method of claim 3, further comprising:
distributing at least a portion of the master scenario events list according to the timestamps; and
recording a plurality of reactions from the plurality of participants.

5. The method of claim 1, wherein the master scenario events list includes the plurality of stimulation events and the plurality of simulation events.

6. The method of claim 1, wherein each of the plurality of stimulation events includes an injection of an action by at least one of the plurality of participants that causes at least one of the plurality of simulation events.

7. The method of claim 1, wherein each of the plurality of simulation events is an effect of at least one of the plurality of stimulation events.

8. The method of claim 1, wherein the plurality of cyber elements includes at least one intended type of attack against a data process.

9. The method of claim 1, wherein the plurality of cyber elements includes at least one intended disruption of a data process.

10. An apparatus for producing an exercise scenario to evaluate an organization's readiness for a situational anomaly, the apparatus comprising:
a processor;
a plurality of user interface devices operatively coupled to the processor; and
a memory device operatively coupled to the processor, the memory device storing a software program to cause the processor and the plurality of user interface devices to facilitate:
identifying a plurality of cyber elements for the exercise scenario;
identifying a plurality of participants for the exercise scenario;
identifying a plurality of objectives for the exercise scenario;
defining a gamespace for the cyber elements of the exercise scenario based on the plurality of participants and the plurality of objectives, the gamespace including an information technology topology and a transaction topology; and
executing a hierarchical process to develop the cyber elements of the exercise scenario based on the plurality of objectives, the hierarchical process including defining a high level problem chain, a detailed problem chain, and a master scenario events list, the high level problem chain including a plurality of high level problem descriptions, the detailed problem chain including a plurality of detailed problem descriptions for each of the high level problem descriptions, each detailed problem description including at least one general ground truth description and at least one general observable effect, and the master scenario events list including at least one of (i) a plurality of stimulation events for each of the detailed problem descriptions and (ii) a plurality of simulation events for each of the detailed problem descriptions, each event in the master scenario events list including at least one detailed ground truth description and at least one detailed observable effect.

11. The apparatus of claim 10, wherein the software program is structured to cause the processor and the plurality of user interface devices to facilitate:
distributing at least a portion of the master scenario events list; and
recording a plurality of reactions from the plurality of participants.

12. The apparatus of claim 10, wherein the master scenario events list includes a timestamp for each of the simulation events.

13. The apparatus of claim 12, wherein the software program is structured to cause the processor and the plurality of user interface devices to facilitate:
distributing at least a portion of the master scenario events list according to the timestamps; and
recording a plurality of reactions from the plurality of participants.

14. The apparatus of claim 10, wherein the master scenario events list includes the plurality of stimulation events and the plurality of simulation events.

15. The apparatus of claim 10, wherein each of the plurality of stimulation events includes an injection of an action by at least one of the plurality of participants that causes at least one of the plurality of simulation events.

16. The apparatus of claim 10, wherein each of the plurality of simulation events is an effect of at least one of the plurality of stimulation events.

17. The apparatus of claim 10, wherein the plurality of cyber elements includes at least one intended type of attack against a data process.

18. The apparatus of claim 10, wherein the plurality of cyber elements includes at least one intended disruption of a data process.

19. A computer readable medium storing instructions structured to cause a computing device to:
identify a plurality of cyber elements for the exercise scenario;
identify a plurality of participants for the exercise scenario;
identify a plurality of objectives for the exercise scenario;
define a gamespace for the cyber elements of the exercise scenario based on the plurality of participants and the plurality of objectives, the gamespace including an information technology topology and a transaction topology; and
execute a hierarchical process to develop the cyber elements of the exercise scenario based on the plurality of objectives, the hierarchical process including defining a high level problem chain, a detailed problem chain, and a master scenario events list, the high level problem chain including a plurality of high level problem descriptions, the detailed problem chain including a plurality of detailed problem descriptions for each of the high level problem descriptions, each detailed problem description including at least one general ground truth description and at least one general observable effect, and the master scenario events list including at least one of (i) a plurality of stimulation events for each of the detailed problem descriptions and (ii) a plurality of simulation events for each of the detailed problem descriptions, each event in the master scenario events list including at least one detailed ground truth description and at least one detailed observable effect.

20. The computer readable medium of claim 19, wherein the instructions are structured to cause the computing device to:
distribute at least a portion of the master scenario events list; and
record a plurality of reactions from the plurality of participants.

21. The computer readable medium of claim 19, wherein the master scenario events list includes a timestamp for each of the simulation events.

22. The computer readable medium of claim 21, wherein the instructions are structured to cause the computing device to:
distribute at least a portion of the master scenario events list according to the timestamps; and
record a plurality of reactions from the plurality of participants.

23. The computer readable medium of claim 19, wherein the master scenario events list includes the plurality of stimulation events and the plurality of simulation events.

24. The computer readable medium of claim 19, wherein each of the plurality of stimulation events includes an injection of an action by at least one of the plurality of participants that causes at least one of the plurality of simulation events.

25. The computer readable medium of claim 19, wherein each of the plurality of simulation events is an effect of at least one of the plurality of stimulation events.

26. The computer readable medium of claim 19, wherein the plurality of cyber elements includes at least one intended type of attack against a data process.

27. The computer readable medium of claim 19, wherein the plurality of cyber elements includes at least one intended disruption of a data process.
